(19) United States
(12) Patent Application Publication
(10) Pub. No.: US 2009/0037582 A1
(43) Pub. Date: Feb. 5, 2009

(54) Method And System For Managing Access To A Resource Over A Network Using Status Information Of A Principal

(76) Inventor: Robert P. Morris, Raleigh, NC (US)

Correspondence Address: SCENERA RESEARCH, LLC, 111 Corning Road, Suite 220, Cary, NC, 27518, US

(21) Appl. No.: 11/831,323

(22) Filed: Jul. 31, 2007

(51) Int. Cl. G06F 21/20; G06F 15/173

(52) U.S. Cl. 709/225

(57) ABSTRACT

Methods and systems are described for managing access to a resource over a network using status information of a principal. One method includes receiving status information for a principal that is allowed to access a resource available via a network communication session with a network service and determining whether the received status information is inconsistent with allowing access to the resource. When the received status information of the principal is inconsistent with allowing access to the resource, the method includes preventing an initiation of a network communication session with the network service for accessing the resource.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

Private networks and computing devices contain valuable resources, such as files, documents, records, applications, and services. Typically access to a desired resource is provided via a network communication session with a network service, which itself can be the desired resource or which manages the desired resource, e.g., a file or document. Because the resources are often sensitive and valuable, they must be protected from malicious and/or unauthorized access.

Numerous security measures have been devised to protect network accessible resources. For example, one measure requires a user seeking access to authenticate himself and to show that he is authorized to such access. Typically, authentication is performed by submitting some form of a username/password key or token, and authentication and authorization are performed including applying an access control rule or list to the authenticated username. This type of protection, however, has its shortcomings when the username/password key is misappropriated and used by an unauthorized user impersonating the authorized user.

Other ways of protecting resources are available. Nevertheless, none have proven completely effective in preventing malicious users skilled in disabling or bypassing security measures from hacking into a protected computer network and system. This is exacerbated by the typical situation where a service for accessing a resource is active even when there are no authorized users accessing the resource. For example, a web server must have at least one communication port open in order to receive requests, authenticate and authorize the requests, and process the requests. Typically, web servers are available 24 hours a day, 7 days a week. Because the communication port is open, there exists some chance that the server can be accessed by an unauthorized user.

Accordingly, there exists a need for methods, systems, and computer program products for protecting sensitive resources, especially when not in use by authenticated and authorized users.

### SUMMARY

Methods and systems are described for managing access to a resource over a network using status information of a principal. One method includes receiving status information for a principal that is allowed to access a resource available via a network communication session with a network service and determining whether the received status information is inconsistent with allowing access to the resource. When the received status information of the principal is inconsistent with allowing access to the resource, the method includes preventing an initiation of a network communication session with the network service for accessing the resource.

In another aspect of the subject matter disclosed herein, a system for managing access to a resource over a network using status information of a principal includes means for receiving status information for a principal that is allowed to access a resource available via a network communication session with a network service, means for determining whether the received status information is inconsistent with allowing access to the resource, and means for preventing an initiation of a network communication session with the network service for accessing the resource when the received status information of the principal is inconsistent with allowing access to the resource.

In another aspect of the subject matter disclosed herein, another system for managing access to a resource over a network using status information of a principal includes a principal monitor component configured for receiving status information for a principal that is allowed to access a resource available via a network communication session with a network service, a session policy manager component configured for determining whether the received status information is inconsistent with allowing access to the resource, and a session controller component for preventing an initiation of a network communication session with the network service for accessing the resource when the received presence information of the principal is inconsistent with allowing access to the resource.

In another aspect of the subject matter disclosed herein, a computer readable medium containing a computer program, executable by a machine, for managing access to a resource over a network using status information of a principal is disclosed. The computer program comprises executable instructions for receiving status information for a principal that is allowed to access a resource available via a network communication session with a network service, determining whether the received status information is inconsistent with allowing access to the resource, and preventing an initiation of a network communication session with the network service for accessing the resource when the received status information of the principal is inconsistent with allowing access to the resource.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating an exemplary system for managing access to a resource over a network using status information of a principal according to an exemplary embodiment;

FIG. 2 is a block diagram illustrating an exemplary status agent according to an exemplary embodiment;

FIG. 3 is a block diagram illustrating an exemplary status device according to an exemplary embodiment;

FIG. 4 is a block diagram illustrating an exemplary access device according to an exemplary embodiment;

FIG. 5 is a flowchart illustrating a method of managing access to a resource over a network using status information of a principal according to an exemplary embodiment;

FIG. 6 is a message flow diagram showing a process of managing access to a resource over a network using status information of a principal according to one embodiment; and

FIGS. 7A-7C are block diagrams illustrating exemplary systems for managing access to a resource over a network using status information of a principal according to several exemplary embodiments.

### DETAILED DESCRIPTION

Methods, systems, and computer program products for managing access to a resource over a network using status information of a principal are disclosed. Typically, a protected resource is accessible by an authorized principal via a network communication session between a client device used by the authorized principal and a network service. A principal can be associated with any entity, including a user, a device, an application, a service, and the like. According to one embodiment, a principal monitor component is configured to receive status information of a principal that is allowed to access a protected resource. A session policy manager component is configured to determine whether the principal's status is inconsistent with a need or possible need to access the protected resource. If the principal's status is inconsistent with a need or possible need to access the protected resource, a session controller component is configured to prevent an initiation of a communication session with the network service thereby preventing access to the protected resource.

The session controller component can prevent the initiation of a communication session with the network service in several ways. For example, in one embodiment, the session controller component can disable one or more communications ports that are associated with the network service so that any requests to initiate a communication session with the network service cannot reach the network service. In other embodiments, other services that support the network service can be disabled, the network service can be closed, and/or the device hosting the network service can be placed in an operating mode that prevents the initiation of communication sessions in general. By preventing the initiation of a communication session with the network service when the status information of the principal is inconsistent with a need to access the protected resource, the possibility of exposing the protected resource, including the network service in some cases, to harm or unauthorized access is substantially reduced if not eliminated.

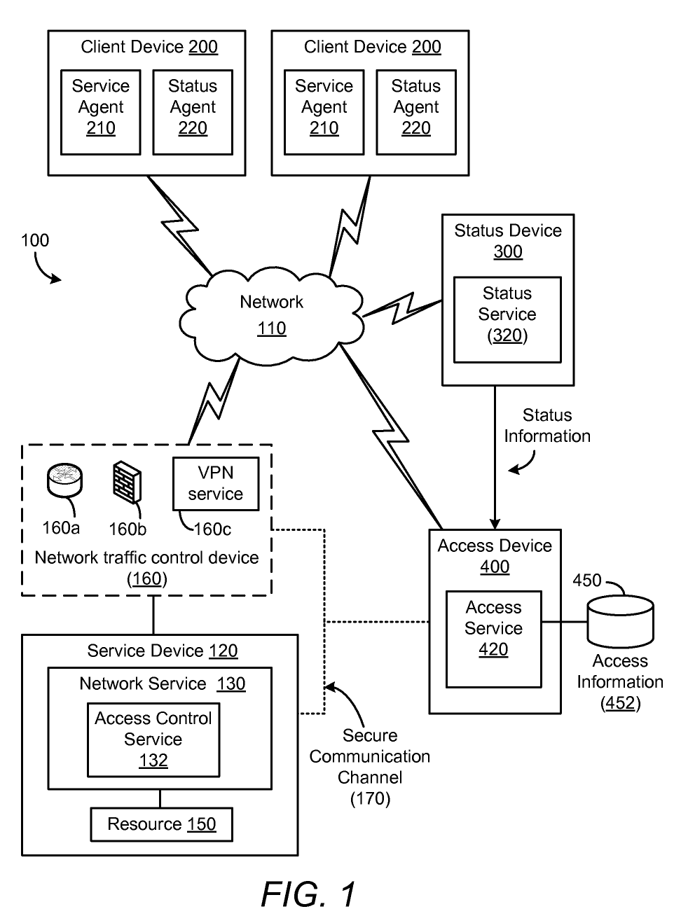

FIG. 1 is a block diagram illustrating an exemplary system according to one embodiment. The system 100 includes a plurality of client devices 200 communicatively coupled to a status device 300 and to a service device 120 by a network 110. The network 110 may be a Local Area Network (LAN) and/or a Wide Area Network (WAN) including the Internet. A client device 200 includes, in one embodiment, a processor, operating system or control program, a network subsystem, input/output subsystems, and memory subsystems (not shown) that support an operating environment allowing a service agent 210 and a status agent 220 to operate in the client device 200.

The service agent 210 is configured to send and receive information to and from the service device 120 over the network 110, while the status agent 220 is configured to send status information on behalf of a principal associated with the client device 200 to the status device 300 over the network 110. In one embodiment, the principal with which the status agent 220 is associated can include a user of the client device 200, an application or service hosted by the device 200, and/or some other component associated with the device 200.

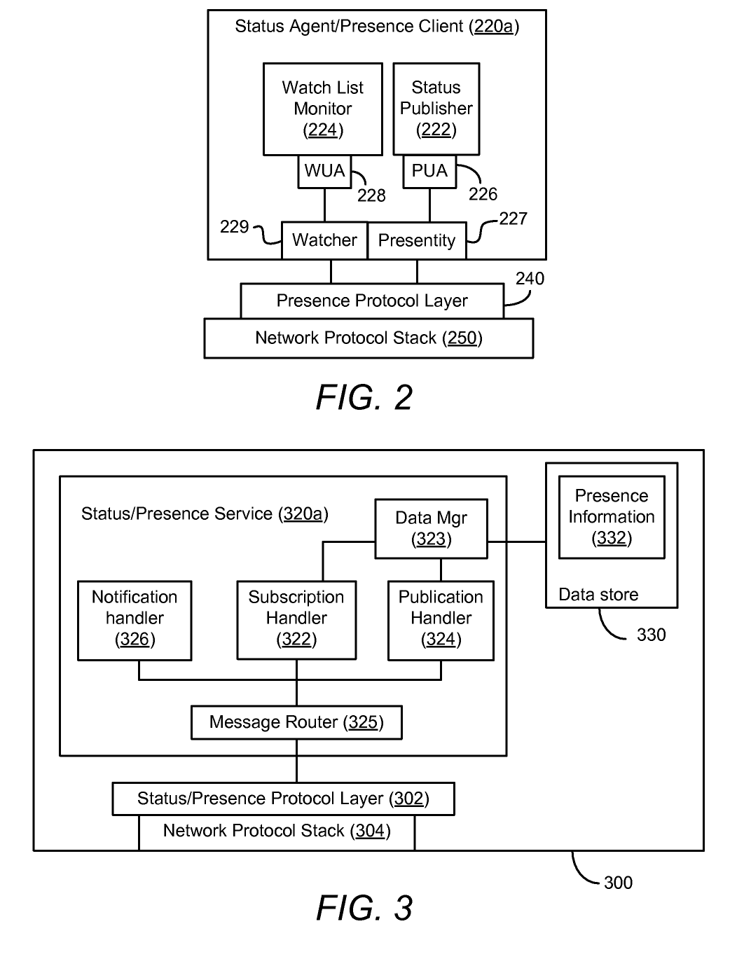

In one embodiment, the status agent 220 can be a presence client such as that depicted in FIG. 2. As such, the status agent/presence client 220a can include a status publisher component 222 that monitors the principal's status and publishes presence information to the status device 300 using a presentity 227 and presentity user agent 226. In this case, the presence information typically includes information about the principal's availability or status. For example, the principal's status can be “available,” “online,” “busy,” or “away.”

The status agent/presence client 220a can also include a watch list monitor component 224 that sends subscription requests and receives notifications, respectively, from the status device 300 using a watcher user agent (WUA) 228 and a watcher entity component 229. In this embodiment, the presence client 220 can use a presence protocol, when sending and/or receiving information over the network 110.

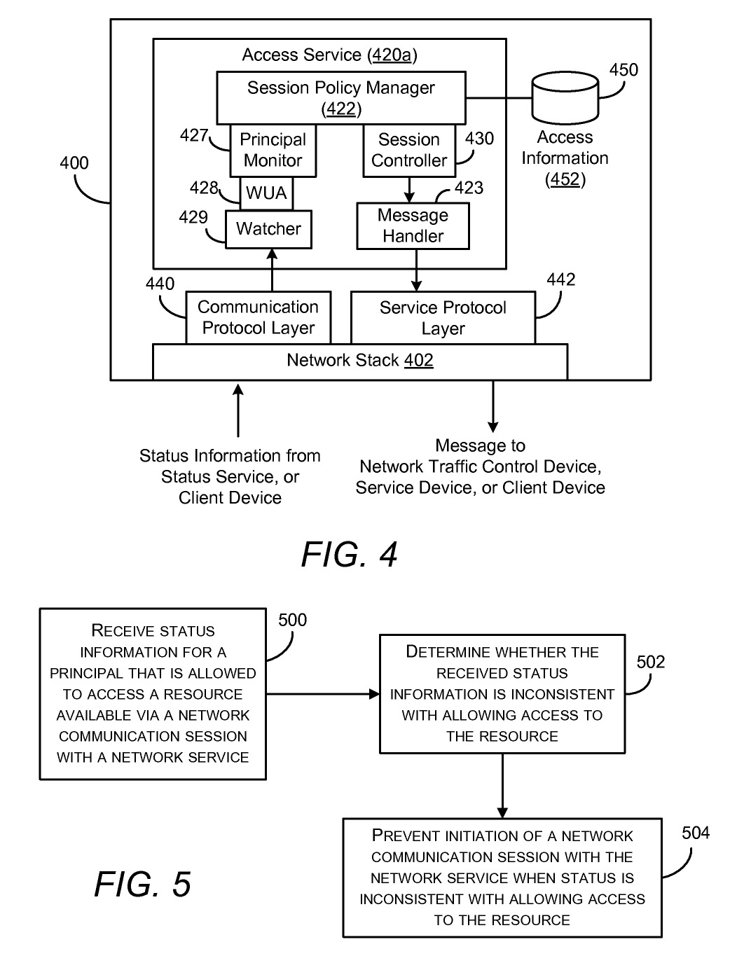

Referring again to FIG. 1, the status device 300 and the service device 120 can be any device, e.g., a server, a laptop computer, a handheld phone, or a PDA, capable of sending and receiving messages over the network 110. In an exemplary embodiment, the status device 300 includes a status service 320 that is configured to receive and manage status information of principals associated with the client devices 200 via the status agents 220. In one exemplary embodiment, the status service 320 can be a presence service such as that depicted in FIG. 3.

As a presence service, the status service 320a, in one embodiment, can receive, manage and store presence information 332 in at least one data store 330. In one exemplary embodiment, the data store 330 can be a relational database that includes a plurality of tables for storing the status information 332. For example, the presence information 332 can be stored in a table that associates an identifier of a principal with presence information 332 including a status for the principal. In another exemplary embodiment, the presence information 332 can be stored in data tuples associated with principals in the data store 330. One skilled in the art can see that other data models can be used that serve similar purposes.

The status/presence service 320a can include a publication handler component 324, a subscription handler component 332, and a notification handler component 326. In one embodiment, the publication handler component 324 can be configured for receiving presence information from the plurality of status agents 220 via the network 110. The subscription handler component 322 can receive and process a subscription to the presence information 332 associated with a principal. The notification handler component 326 can be configured to generate and send notification messages including status updates to watchers associated with subscribing clients via the network 110.

Referring again to FIG. 1, the service device 120, in one exemplary embodiment, hosts a resource 150 available via a network communication session with a network service 130. For example, a resource 150 can include, but is not limited to, a file, a document, a record, an application, a service, a database or any other object supported by the service device 120. In some embodiments, the resource 150 can also include the network service 130. A communication session can be connection oriented using, for example, a TCP connection or can be connectionless using, for example, a UDP datagram service. Other exemplary protocols within the scope of this document include various versions of SNA, SPX/IPX, NetBIOS, and various link layer protocols such as ATM.

The resource 150 can be protected from unauthorized access by an access control service 132, which authenticates and authorizes users or principals requesting to access the resource 150. While shown in the network service 130, the access control service 132 can also reside outside of the network service 130 where it can authenticate and authorize principals for the network service 130 and other services (not shown) hosted by the service device 120. Information entering and exiting from the service device 120 can be monitored and controlled by at least one network traffic control device 160, including a switch, hub, or router 160a, a firewall 160b, a VPN service 160c, and the like.

In many corporate environments, a principal may need access to the resource 150 and/or network service 130 at any time. Accordingly, the network service 130 must be available at all times. As stated above, the access control service 132 typically protects the network service 130 and the resource 150 from unauthorized access. Nevertheless, the access control service 132 cannot always prevent access by a malicious user who is impersonating an authorized user, or by a highly skilled and persistent hacker.

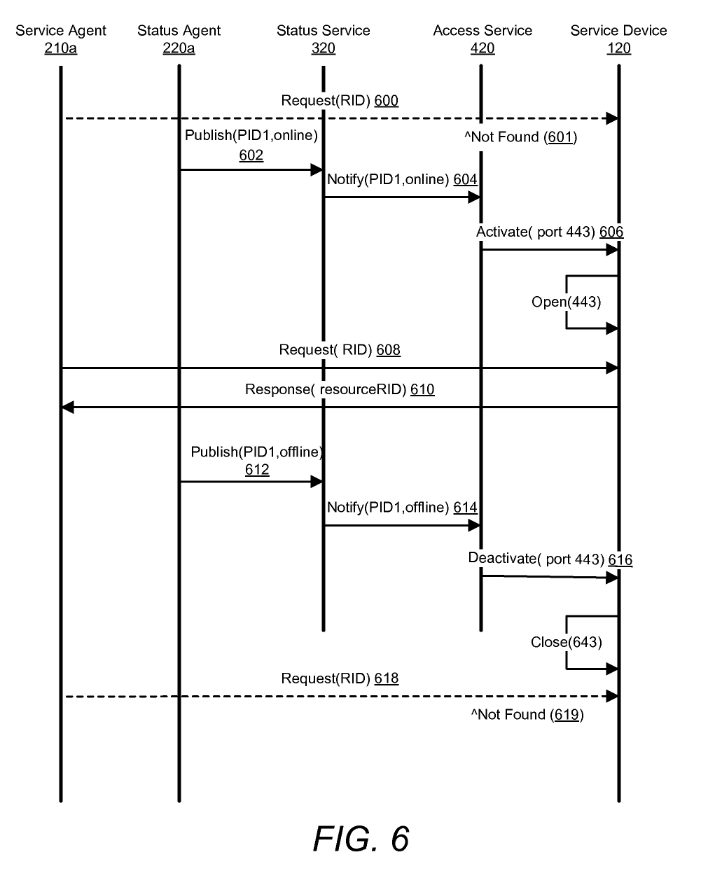

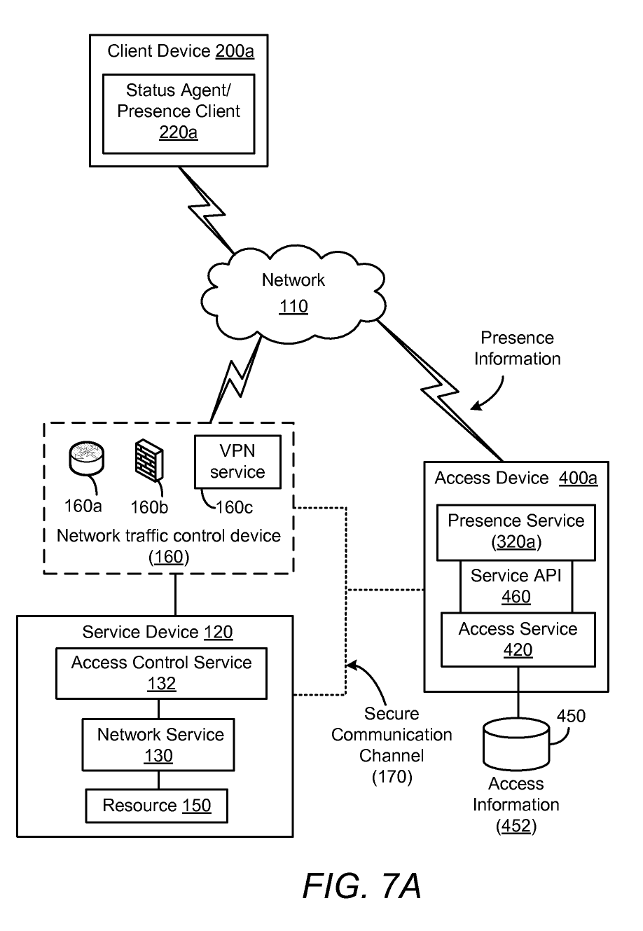

To address this issue, the system 100, according to one embodiment, includes an access device 400 that hosts an access service component 420. The access service component 420, in one embodiment, is configured to manage access to the resource 150 over the network 110 using status information of a principal that is allowed to access the resource 150. To describe the functionality of the access service 420, reference to FIG. 4 and FIG. 5 is made. FIG. 4 is a block diagram depicting an exemplary access device 400 that supports a presence protocol according to one embodiment, and FIG. 5 is a flowchart of an exemplary method for managing access to the resource 150 using status information of a principal according to one embodiment.

Referring first to FIG. 1 and FIG. 5, the exemplary process begins when the access service component 420 receives status information for a principal that is allowed to access a resource, e.g., 150, available via a network communication session with a network service, e.g., 130 (block 500). In one embodiment, the access service component 420 includes means for receiving the status information for the principal from, for example, the status service 320 in the status device 300 and/or from the client device 200 associated with the principal. For example, referring now to FIG. 4, the access service component 420a can be implemented as a presence client that includes a principal monitor component 427 that is configured to receive presence information for the principal from the status/presence service 320a depicted in FIG. 3 and/or the status agent/presence client 220a depicted in FIG. 2.

According to one embodiment, the principal monitor 427 of the access service component 420a can subscribe to status updates of principals allowed to access the resource 150 by sending subscription requests via a watcher component 429 interoperating with a communication protocol layer 440 operatively coupled to a network protocol stack 402, such as a TCP/IP stack, over the network 110 to the status/presence service 320a. Accordingly, the principal monitor 427 can receive a status update of a principal when the principal publishes its updated presence information to the status/presence service 320a, which then sends a notification message that includes the updated status to the watcher component 429 pursuant to the subscription. The watcher component 429 provides the updated status to the principal monitor 427 via a watcher user agent (WUA) component 428 providing an interface between the principal monitor component 427 and the watcher component 428. In another embodiment, the principal monitor component 427 can receive status updates directly from the status agent/presence client 220a associated with the principal.

Referring again to FIG. 5, once the status information for the principal is received, the access service component 420 determines, in one embodiment, whether the received status information is inconsistent with allowing access to the resource 150 (block 502). According to an exemplary embodiment, the access service component 420 includes means for determining whether the received status information is inconsistent with allowing access to the resource. For example, referring to FIG. 4, the access service component 420a can include a session policy manager component 422 configured for making this determination.

In one embodiment, when the watcher component 429 receives the notification message via the network 110 as provided for by the network stack 402 and the communication protocol layer 440, the watcher entity 429 can parse the notification message and can provide the status information in the notification message to the WUA 228. The WUA 228 provides an interface between the principal monitor component 427 and the watcher entity 429, and processes the status information so that at least a portion of the received status information can be interpreted by the principal monitor component 427 that maintains subscriptions for watched principals and provides principal status information to the session policy manager component 422.

The session policy manager component 422, in one embodiment, is configured for managing access information 452 stored in a data store 450. The access information 452, in an exemplary embodiment, associates status information with an access condition, which indicates whether access to the resource is allowable based on the status information. For example, in some cases, the status value of “offline” can be associated with an access condition of “inconsistent.”

In another embodiment, the access condition can be based on the status information and on the satisfaction of one or more criteria. For example, access to the resource can be based on the principal's status information and on the status information of at least one other principal corresponding to a second client device 200. That is, if the resource 150 is one that is shared between user A and user B, and user A's is allowed to access the resource 150 only when user B is also accessing the resource 150, then the access condition for the resource 150 can be based on the status information of both user A and user B. In this example, the access condition will be “inconsistent” if user A's status is consistent with allowing access to the resource 150, e.g., “online,” but user B's status is inconsistent with allowing access to the resource 150, e.g., “offline.”

In other embodiments, the access condition can be based on the principal's status information and on other factors such as at least one of an attribute associated with another entity, access control rules for the resource 150, and an indication as to when the principal is allowed access to the resource. For example, the principal's access to the resource 150 can be restricted to a specific time or ordered by a queue. Thus, while the principal's status, by itself, may be consistent with accessing the resource, the access condition will be “inconsistent,” if the principal is not allowed to access the resource at that time.

In some embodiments, the access information 452 can be associated with the principal such that the access conditions can be specific to the principal's status information. Alternatively or in addition, the access information 452 can be associated with the resource 150 so that the access conditions apply to all of the principals wishing to access the resource 150. In another embodiment, the access information 452 can be associated with a group of principals such that the access conditions apply to the group of principals. In some embodiments, the access information 452 can also include additional information such as whether the principal is allowed to access the resource 150 and under what additional conditions access to the resource 150 is allowable, as discussed above. Clearly, the access information 452 can be managed in a variety of ways and the embodiments described above are not meant to be exhaustive.

In an exemplary embodiment, the session policy manager component 422 is configured for determining whether the received status information is inconsistent with allowing access to the resource 150 by analyzing the access information 452 associated with at least one of the principal, the resource 150, and/or the group of principals to which the principal is a member. In one embodiment, the session policy manager component 422 can retrieve the applicable access information 452 from the data store 450 and determine whether the received status information is inconsistent with allowing access to the resource 150 based on the access condition associated with the status information.

Referring again to FIG. 5, when the received status information of the principal is inconsistent with allowing access to the resource 150, the access service component 420 is configured to prevent an initiation of a network communication session with the network service 130 for accessing the resource 150 according to the exemplary embodiment (block 504). According to an exemplary embodiment, the access service component 420 includes means for preventing the initiation of a network communication session with the network service 130 for accessing the resource 150. For example, referring to FIG. 4, the access command handler component 420 can include a session controller component 430 configured for performing this function.

According to the exemplary embodiment, when the received status information of the principal is inconsistent with allowing access to the resource 150, a communication session with the network service 130 for accessing the resource 150 is prevented to protect the service 130 and resource 150. This is in contrast to typical security measures, where the principal using a client device is allowed to send a message to the access control service 132 in the network service 130, which executes an authentication and/or authorization process to determine whether the principal is allowed or denied access to the network service 130. In the exemplary embodiment described here, the principal using any client device is not allowed to communicate with the network service 130, the access control service 132 or, in some embodiments, any other executable operating in the service device 120. Accordingly, if another user is impersonating the principal, that user will be prevented from accessing the resource and a hacker will be prevented from hacking into the network service 130, and in some cases, into the service device 120.

In one embodiment, when the current status information for the principal is consistent with allowing access to the resource 150, e.g., the principal's status is “online,” and the session policy manager component 422 determines that the received status information of the principal is inconsistent with allowing access to the resource 150, e.g., the received status is “offline,” the session controller component 430 as directed by the session policy manager 422 can invoke a message handler component 423 to generate a message that includes at least one command, which when executed prevents an initiation of a network communication session with the network service 130 for accessing the resource 150. In one embodiment, the message can be sent via a service protocol layer 442 and a network stack 402 to at least one of the service device 120, one or more network traffic control devices 160, and the client device 200 associated with the principal. The at least one command varies according to which device the message is sent.

For example, according to one embodiment, the message can be sent to the service device 120 via a secure communication channel 170 between the access service component 420 and the service device 120, as depicted in FIG. 1. In this embodiment, the service device 120 typically provides at least one communication port that is associated with the network service 130 for accessing the resource 150, and the message can include a command to close the associated communication port, thereby disallowing the establishment of a communication session between the principal and the network service 130. In another embodiment where the access control service 132 resides outside of the network service 130, the message can include a command that denies access to the access control service so that the principal and other authorized users are prevented from authenticating/authorizing themselves. In addition or alternatively, the message can include a command to shut down the network service 130, a command to restrict other services supported by the service device 120 including operating system managed threads, memory and persistent storage, a command instructing the service device 120 to enter an operating mode that disables access to the network service 130 and resource 150, and/or a command instructing the service device 120 to power off.

In another embodiment, the message can be sent to one or more network traffic control devices 160 that control network traffic into and out of the service device 120. In this case, the message can include a command to disallow access to the service device 120 by the principal, a group of principals and/or all principals. In other embodiments, the message can be sent to the client device 200 associated with the principal over the network 110. In this case, the message can include a command to disable network communications to a network address corresponding to the network service 130, the service device 120, and/or a subnet (not shown) including the service device 120. In addition or alternatively, the message can include a command to disable the service agent 210 used to communicate with the network service 130, and/or a command to reconfigure the service agent 210 such that the agent 210 is unable to establish a communication session with the network service 130.

According to various embodiments, the message can include one or more commands that prevent the initiation of a network communication session with the network service 130 by the principal alone, by a plurality of principals, and/or by all principals authorized to access the resource 150. In one embodiment, the degree of accessibility can be based on the resource 150, including the network service 130, the number of other principals allowed access to the resource 150, and other situation specific conditions.

For example, the service device 120 can be a desktop computer of a principal and the principal uses a client device 220, e.g., a PDA, which includes a status agent 220 for publishing the principal's status to a status service 320. Ordinarily, the principal's desktop computer 120 is operational, i.e., powered on and connected to the network 110, so that the principal can access resources 150 in the computer at all times, e.g., during travel or on a field service call. When the principal's status, as published by the client device 220, is one that is inconsistent with accessing the resources 150, e.g., “sleeping,” “driving,” or “offline,” the desktop computer can be powered down or at least disconnected from the network 110 so that no one can attempt to access the network service 130 in the computer 120.

The discussion above is focused on preventing the initiation of a communication session with the network service 130 for accessing the resource 150 when the current status information of the principal is consistent with allowing access to the resource 150 and the received status information of the principal is inconsistent with allowing access to the resource 150. A similar discussion is applicable when the current status information of the principal is inconsistent with allowing access to the resource 150 and the received status information of the principal is consistent with allowing access to the resource 150. In this case, the access service component 420 can enable the initiation of a communication session with the network service 130 by generating a message including a command to enable the initiation of communication sessions with the network service 130 and sending the message to the service device 120, the traffic control devices, and/or the client device 200.

For example, in one exemplary embodiment, the access service component 420 can send a message to service device 120 via the secure communication channel 170, where the message includes a command to open all communication ports used by the network service 130. The command, in other embodiments, can direct the service device 120 to wake-up from a suspended, hibernation, or other low power state. The command can be sent to start the network service 130, provide resources such as operating system managed threads, memory, persistent storage, internal messaging utilities such as queues and pipes available to the network service 130. Further, the command can instruct the service device 120 to enable network access, or can instruct the device's 120 NIC to start the device 120 when shutdown.

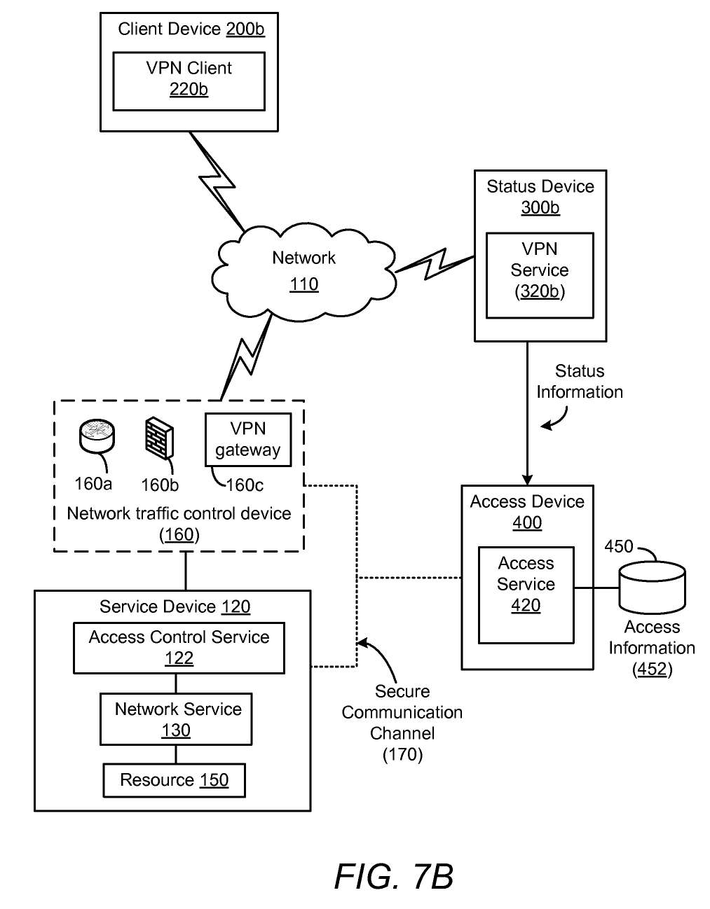

To illustrate further the aspects of one embodiment, FIG. 6 is a message flow diagram showing a process of managing access to a resource over a network using status information of a principal according to one embodiment. In the exemplary message flow, the current status information for the principal associated with a client device 200 is inconsistent with allowing access to the resource 150. Accordingly, a message (600) including a request to initiate a communication session with a network service 130 in a service device 120 is bounced. For example, a “not found” response (601) is returned to the service agent 210 that sent the message (600) because the communication port associated with the network service 130 is disabled.

Next the principal uses the client device's status agent 220 to send a publish message (602) to the status service 320 providing status information including an identifier of the principal, e.g., PID1, and the status, e.g., “online,” of the principal. The status service 320, in turn, generates a notification message (604) that includes the principal's status information comprising, in this exemplary process, the principal's identifier and the status of the principal, and sends the notification message (604) to the access service component 420 where it is received by the principal monitor component 427.

The session policy manager component 422 included in the access service component 420 determines whether the received status information provided by the principal monitor component 427 is inconsistent or consistent with allowing the initiation of a communication session with the network service 130. In this case, because the received status information is consistent with allowing a communication session, the session controller 430 included in the access service component 420 generates a message (606) including a command to activate a communication port associated with the network service 130 (port 443) as directed by the determination of the session policy manager 422. The message (606) is sent to the service device 120, which executes the command by opening communication port 443. Now, when the service agent 210 sends a message (608) including a request to initiate a communication session with the network service 130 in the service device 120, the service device 120 returns a response (610) initiating the network communication session.

Next, when principal logs off, the status agent 220 sends a publish message (612) to the status service 320 providing status information indicating that the status of the principal is now “offline.” The status service 320 generates a notification message (614) that includes the principal's updated status information and sends the notification message (614) to the access service component 420.

The access service component 420 determines that the received status information is inconsistent with allowing the initiation of a communication session with the network service 130 in a manner analogous to that just described for processing the notify message 604. In this case, the access service component 420 generates a message (616) including a command to deactivate the communication port associated with the network service 130 (port 443). The message (616) is sent to the service device 120, which executes the command by closing communication port 443. Now, when the service agent 210 sends a message (618) including a request to initiate a communication session with the network service 130 in the service device 120, the communication port 443 is closed and the service device 120 returns a “not found” response (619).

As described above, the status information received by the access service component 420 can be presence information published by a status agent/presence client 220a, shown in FIG. 2, via a status/presence service 320a, shown in FIG. 3. In this embodiment, the access service component 420a is hosted by the access device 400 and includes a principal monitor 427, shown in FIG. 4, which subscribes to the status information at the presence service 320a via a watcher component 429.

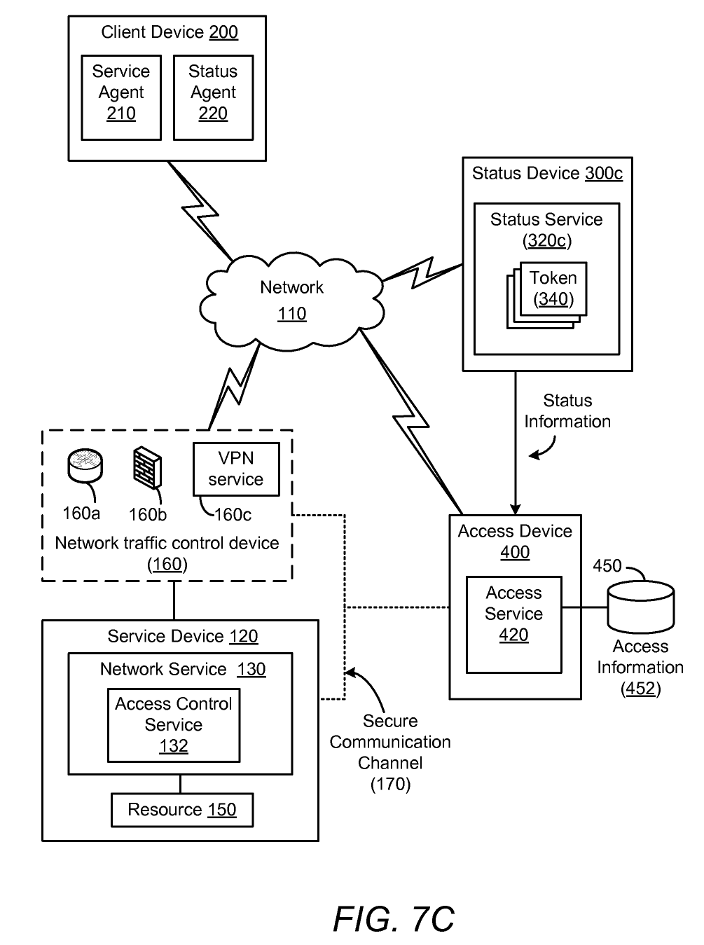

In another embodiment, shown in FIG. 7A, the access device 400a can host the presence service 320a and the access service 420. In this embodiment, the access service component 420 can receive the status information through a service application programming interface (API) 460 provided by the presence service 320a for supporting an application's use of status information. For example, the service API 460 can be similar to that which is described in co-pending U.S. patent application Ser. No. 11/323,762 entitled “METHOD AND APPARATUS FOR PROVIDING CUSTOMIZED SUBSCRIPTION DATA,” filed on Dec. 30, 2005, and commonly owned with the present application and herein incorporated by reference. In one embodiment, the service API 460 enables the presence service 320a to pass notification messages to the principal monitor 427 included in the access service component 420. Because the service API 460 is independent of both the transport and presence protocols, messages can be exchanged freely and securely between the presence service 320a and the access service component 420.

In another embodiment, shown in FIG. 7B, the status agent can be implemented as a VPN client 210b and the status service can be implemented as a remote VPN service 320b. In this embodiment, when the principal associated with the client device 200b wishes to access the resource 150, the principal launches the VPN client 210b to log into the VPN service 320b, which establishes a VPN connection with the service device 120 via the VPN gateway 160c. When the VPN client 210b logs out, the VPN service 320b terminates the VPN connection. According to this exemplary embodiment, when the VPN client 210b logs in or logs out, the VPN service 320b can send to the principal monitor component 427 of the access service component 420 status information for the principal in the form of an indication that the VPN client 210b associated with the principal is interacting with the VPN service 320b. The access service component 420, in one embodiment, receives the status information/indication via the principal monitor component 427 and determines whether the status information/indication is inconsistent with allowing access to the resource 150 via the session policy manager component 422.

For example, an indication indicating a valid login to the VPN service 320b is a status that is consistent with allowing access. An indication indicating a valid logout is a status inconsistent with allowing access. In one embodiment, when no VPN connections are established and no local users are connected to the service device 120, the service device 120 can be powered down or put in a low power state. When a VPN client 210b logs in to the VPN service 320b, resources 150 are made available by activating the service device 120 and network service 130 via the session controller component 430 of the access service component 420.

In another embodiment, shown in FIG. 7C, the status service 320c can make a token 340 available to the principal, which the principal can retrieve using the status agent 220 in the client device 200. In one embodiment, retrieval of the token 340 causes the status service 320c to send a message to the access service component 420, which then acts to make the resource 150 accessible. That is, the retrieval of the token 340 is the status indication that the status of the principal is consistent with allowing access to the resource 150.

According to aspects of the embodiments described, the principal monitor component 427 of the access service component 420 receives status information of a principal that is allowed to access a protected resource 150 available via a network communication session with a network service 130. The session policy manager component 422 of the access service component 420 determines whether the principal's status is inconsistent with allowing access to the protected resource 150. If the principal's status is inconsistent with allowing access to the protected resource 150, the session controller component of the access service component 420 is configured to prevent an initiation of a network communication session with the network service 130 thereby preventing access to the protected resource 150. By preventing the initiation of a communication session with the network service when the status information of the principal is inconsistent with a need to access the protected resource, the possibility of exposing the protected resource, including the network service in some cases, to harm or unauthorized access is substantially reduced if not eliminated.

In some cases, the communication session is prevented by powering down the service device 120 or by putting the service device 120 in a low power state. In these cases, the resources 150 are protected from unauthorized access and energy consumption is reduced. This feature can be advantageous for large business enterprises and universities that operate several hundred servers and desktop computers. By powering down a desktop computer when a user's status is inconsistent with a need or possible need to access a protected resource on the computer, an entity can conserve energy and reduce its expenses.

Through aspects of the embodiments described, access to protected resources 150 over a network can be managed using the status information of a principal who is allowed to access the protected resource 150. It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g), or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for managing access to a resource over a network using status information of a principal, the method comprising:
receiving status information for a principal that is allowed to access a resource available via a network communication session with a network service;
determining whether the received status information is inconsistent with allowing access to the resource; and
preventing an initiation of a network communication session with the network service for accessing the resource when the received status information of the principal is inconsistent with allowing access to the resource.

2. The method of claim 1 further comprising storing access information that associates status information with an access condition, wherein the access condition indicates whether access to the resource is allowable based on the status information.

3. The method of claim 1 wherein preventing an initiation of a network communication session includes preventing an initiation of a network session with the network service for accessing the resource for at least one of the principal, a plurality of principals, and all principals authorized to access the resource.

4. The method of claim 1 wherein determining whether the received status information is inconsistent with allowing access to the resource includes determining an access condition associated with the received status information.

5. The method of claim 1 wherein preventing the initiation of the communication session includes:
sending a message to a device hosting the network service, wherein the device supports at least one communication port associated with the network service for accessing the resource and the message includes at least one of a command to close the associated communication port, thereby disallowing the establishment of a communication session between the principal and the network service, a command to shut down the network service, a command to restrict other services supported by the device including operating system managed threads, memory and persistent storage, a command to enter an operating mode that disables access to the resource, and a command to power off.

6. The method of claim 1 wherein preventing the initiation of the communication session includes:
sending a message to a network traffic control device that controls network traffic into and out of a service device hosting the network service, wherein the network traffic control device includes a switch, a router, a firewall, and a virtual private network service, and wherein the message includes a command to disallow access to the service device by the principal.

7. The method of claim 1 wherein preventing the initiation of the communication session includes:
sending a message to a device associated with the principal, wherein the message includes at least one of a command to disable network communications to a network address corresponding to one of the network service, a service device hosting the network service, and a subnet including the service device, a command to disable an agent used to communicate with the network service, and a command to reconfigure the agent used to communicate with the network service such that the agent is unable to establish a communication session with the network service.

8. The method of claim 1 further comprising:
providing an access control service for restricting access to the resource to authorized users; and
denying access to the access control service when the received status information of the principal is inconsistent with allowing access to the resource.

9. The method of claim 1 wherein receiving status information for a principal that is allowed to access a resource available via a network communication session with a network service includes receiving an indication that the principal has retrieved a token.

10. The method of claim 1 wherein determining whether the received status information of the first principal is inconsistent with allowing access to the resource is based on the received status information of the principal and on at least one of status information for a second principal, an attribute associated with another entity, access control rules for the resource, and an indication as to when the principal is allowed access to the resource.

11. The method of claim 1 wherein receiving status information for a principal that is allowed to access a resource available via a network communication session with a network service includes receiving an indication that a VPN client associated with the principal is interacting with a VPN service associated with a service device hosting the network service.

12. A computer readable medium containing a computer program, executable by a machine, for managing access to a resource over a network using status information of a principal, the computer readable medium comprising instructions for:
receiving status information for a principal that is allowed to access a resource available via a network communication session with a network service;
determining whether the received status information is inconsistent with allowing access to the resource; and
preventing an initiation of a network communication session with the network service for accessing the resource when the received status information of the principal is inconsistent with allowing access to the resource.

13. The computer readable medium of claim 12 further comprising instructions for storing access information that associates status information with an access condition, wherein the access condition indicates whether access to the resource is allowable based on the status information.

14. The computer readable medium of claim 12 comprising instructions for preventing an initiation of a network session with the network service for accessing the resource for at least one of the principal, a plurality of principals, and all principals authorized to access the resource.

15. The computer readable medium of claim 12 further comprising instructions for:
sending a message to a service device hosting the network service, wherein the service device supports at least one communication port associated with the network service for accessing the resource and the message includes at least one of a command to close the associated communication port, thereby disallowing the establishment of a communication session between the principal and the network service, a command to shut down the network service, a command to restrict other services supported by the service device including operating system managed threads, memory and persistent storage, a command to enter an operating mode that disables access to the network service, and a command to power off.

16. The computer readable medium of claim 12 further comprising instructions for:
sending a message to a network traffic control device that controls network traffic into and out of a service device hosting the network service, wherein the network traffic control device includes a switch, a router, a firewall, and a virtual private network gateway service, and wherein the message includes a command to disallow access to the service device by the principal.

17. The computer readable medium of claim 12 further comprising instructions for:
sending a message to a device associated with the principal, wherein the message includes at least one of a command to disable network communications to a network address corresponding to one of the network service, a service device hosting the network service, and a subnet including the service device, a command to disable an agent used to communicate with the network service, and a command to reconfigure the agent used to communicate with the network service such that the agent is unable to establish a communication session with the network service.

18. The computer readable medium of claim 12 further comprising instructions for:
denying access to an access control service for restricting access to the resource to authorized users when the received status information of the principal is inconsistent with allowing access to the resource.

19. The computer readable medium of claim 12 further comprising instructions for receiving an indication that the principal has retrieved a token and determining whether the received indication is inconsistent with allowing access to the resource.

20. The computer readable medium of claim 12 further comprising instructions for determining whether the received status information of the first principal is inconsistent with allowing access to the resource is based on the received status information of the principal and on at least one of status information for a second principal, an attribute associated with another entity, access control rules for the resource, and an indication as to when the principal is allowed access to the resource.

21. The computer readable medium of claim 12 further comprising instructions for receiving an indication that a VPN client associated with the principal is interacting with a VPN service associated with a service device hosting the network service and determining whether the received indication is inconsistent with allowing access to the resource.

22. A system for managing access to a resource over a network using status information of a principal, the system comprising:
means for receiving status information for a principal that is allowed to access a resource available via a network communication session with a network service;
means for determining whether the received status information is inconsistent with allowing access to the resource; and
means for preventing an initiation of a network communication session with the network service for accessing the resource when the received status information of the principal is inconsistent with allowing access to the resource.

23. A system for managing access to a resource over a network using status information of a principal, the system comprising:
a principal monitor component configured for receiving status information for a principal that is allowed to access a resource available via a network communication session with a network service;
a session policy manager component configured for determining whether the received status information is inconsistent with allowing access to the resource; and,
a session controller component configured for preventing an initiation of a network communication session with the network service for accessing the resource when the received status information of the principal is inconsistent with allowing access to the resource.

24. The system of claim 23 further comprising a data store for storing access information that associates status information with an access condition, wherein the access condition indicates whether access to the resource is allowable based on the status information.

25. The system of claim 23 wherein the session controller component is configured for preventing an initiation of a network session with the network service for accessing the resource for at least one of the principal, a plurality of principals, and all principals authorized to access the resource.

26. The system of claim 23 wherein the service policy manager component is configured for determining whether the received status information is inconsistent with allowing access to the resource by determining an access condition associated with the received status information.

27. The system of claim 23 wherein the session controller service component is configured for sending a message to a service device hosting the resource, wherein the service device supports at least one communication port associated with the network service for accessing the resource and the message includes at least one of a command to close the associated communication port, thereby disallowing the establishment of a communication session between the principal and the network service, a command to shut down the network service, a command to restrict other services supported by the service device including operating system managed threads, memory and persistent storage, a command to enter an operating mode that disables access to the network service, and a command to power off.

28. The system of claim 23 wherein a message handler component responsive to the session controller component is configured for sending a message to a network traffic control device that controls network traffic into and out of a service device hosting the resource, wherein the network traffic control device includes a switch, a router, a firewall, and a virtual private network service, and wherein the message includes a command to disallow access to the service device by the principal.

29. The system of claim 23 wherein a message handler responsive to the session controller is configured for sending a message to a device associated with the principal, wherein the message includes at least one of a command to disable network communications to a network address corresponding to one of the network service, a service device hosting the resource, and a subnet including the service device, a command to disable an agent used to communicate with the network service, and a command to reconfigure an agent used to communicate with the network service such that the agent is unable to establish a communication session with the network service.

30. The system of claim 23 wherein the session controller component is configured for denying access to an access control service when the received status information of the principal is inconsistent with allowing access to the resource.

31. The system of claim 23 wherein the principal monitor component is configured for receiving an indication that the principal has retrieved a token; and,
the session policy manager component is configured for determining whether the received indication is inconsistent with allowing access to the resource.

32. The system of claim 23 wherein the session policy manager component is configured for determining whether the received status information of the first principal is inconsistent with allowing access to the resource based on the received status information of the principal, and on at least one of status information for a second principal, an attribute associated with another entity, access control rules for the resource, and an indication as to when the principal is allowed access to the resource.

33. The system of claim 23 wherein the principal monitor component is configured for receiving an indication that a VPN client associated with the principal is interacting with a VPN service associated with a service device hosting the network service; and,
the session policy manager component is configured for determining whether the received indication is inconsistent with allowing access to the resource.
